(19) United States
(12) Patent Application Publication
(10) Pub. No.: US 2004/0070099 A1
(43) Pub. Date: Apr. 15, 2004

(54) Method and device for compressing granular materials

(76) Inventor: Hubert Bald, Bad Berleburg (DE)

Correspondence Address: ALIX YALE & RISTAS LLP, 750 MAIN STREET, SUITE 1400, HARTFORD, CT, 06103, US

(21) Appl. No.: 10/416,556

(22) PCT Filed: Nov. 10, 2001
(86) PCT No.: PCT/DE01/04191

(30) Foreign Application Priority Data
Nov. 11, 2000 (DE) 100 56 063.6
Dec. 6, 2000 (DE) 100 60 860.4

(51) Int. Cl. B06B 1/02

(52) U.S. Cl. 264/71; 264/443; 264/72; 425/431; 425/432

(57) ABSTRACT

The invention relates to a method and device for the compression of granular materials. On compressing granular material to give prepared products e.g. concrete paving slabs, a resonance vibrator with an oscillating mass-spring system is applied, which may be energised by a controllable energiser to produce forced oscillation of a given frequency and oscillatory amplitude. The resonant effect, making use of the proximity of the inherent resonance frequency and the exciter frequency permits a reduction in the size of the exciter force. According to the invention, along with an adjustment of the exciter frequency the resonant frequency is also simultaneously co-adjusted by means of a suitable adjuster, in order to be able to g make use of the resonance effect throughout the whole spectrum of the exciter frequencies to be carried out.

The invention relates to a method and an apparatus for compacting granular materials. Primarily concerned here are compacting methods in which the granular materials are molded in molding boxes to form finished products, for example for the production of concrete blocks in concrete block-making machines. However, the compacting may also concern compacting of ground surfacings consisting of granular materials, for example highway surfacings. The invention relates quite specifically to such methods in which vibrators with an oscillatory mass-spring system are used for carrying out compacting work, the operating frequency of the vibrators being close to the natural frequency of the mass-spring system.

The mass-spring systems are in this case excited by an exciter which is adjustable with respect to its frequency for carrying out enforced oscillations, the exciter generating periodic portions of excitation energy, which are preferably also influenceable in their magnitude. When producing concrete blocks in concrete block-making machines, in the case of the methods coming into consideration here a specific frequency range is adjusted in steps or continuously passed through during a compacting operation, in order to be able to excite in the mass to be compacted different natural frequencies of the constituents of the granular mass.

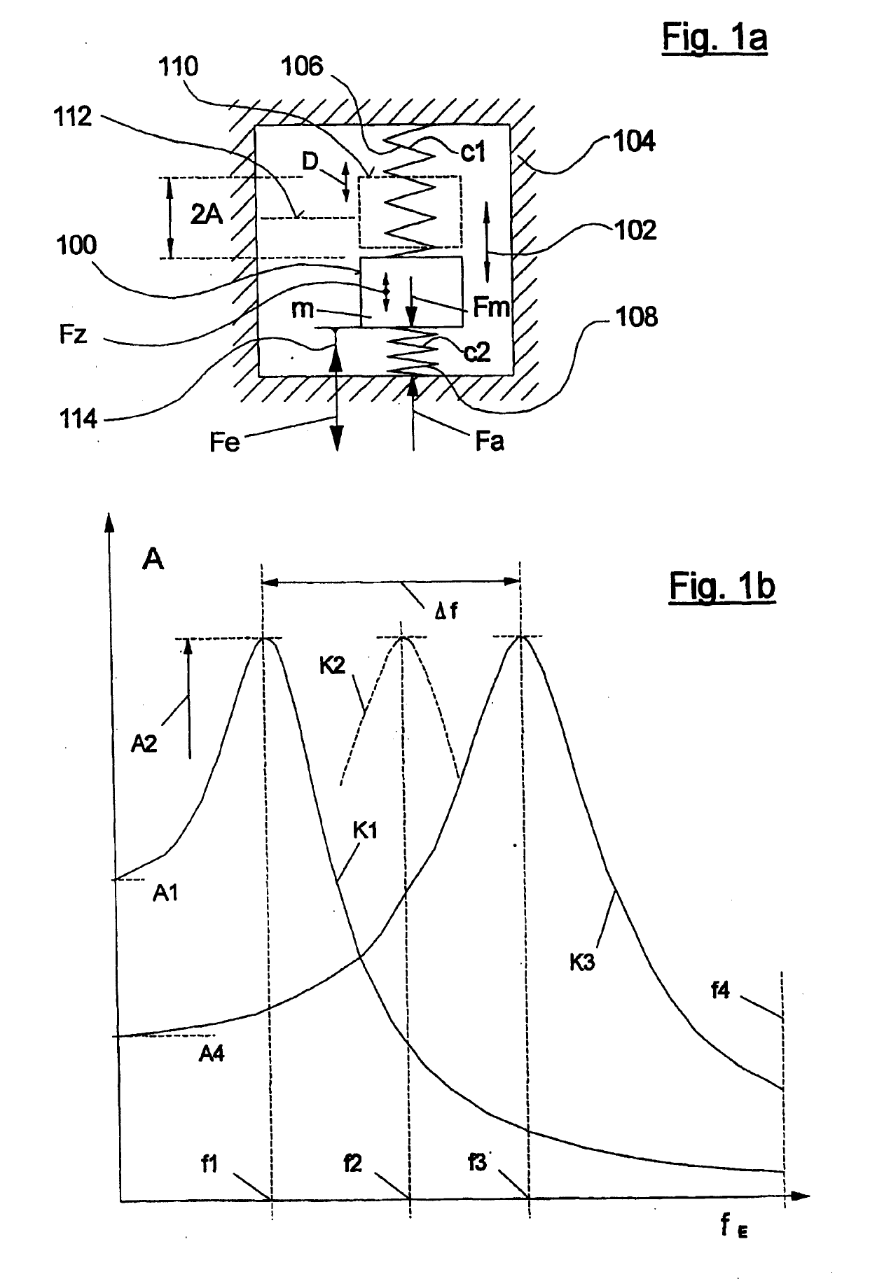

If in the case of the last-mentioned method the exciter frequency approaches the natural frequency of the mass-spring system established by the stored spring energy (determined for example by the spring rate “c”) and the (co-oscillating) mass “m”, then, depending on the magnitude of the existing damping “D” and assuming constant magnitude of the exciter force amplitude of the exciter, there is a proliferation of particularly great values of oscillating excursion amplitudes “A” and oscillation acceleration amplitudes. [Resonance occurs when the natural frequency and the exciter frequency coincide (point of resonance). Curves which can be calculated and recorded as a function of the increase in the oscillating excursion amplitude A with respect to the static deformation of the spring as a result of the applied exciter force amplitude in dependence on the damping D and on the exciter frequency f are also known as “resonance curves” (see also FIG. 1b). However, the usable effect of the increase in the oscillating excursion amplitude (the resonance effect) is not restricted to the point of resonance, but may deviate from the resonant frequency f₀ upward and downward by considerable amounts]. Since high oscillating accelerations are desired in the case of compacting methods of this type, the resonance effect is also exploited here, as described for example in the document representing the prior art of EP 0 870 585 A1. Since, in the case of the methods coming into consideration in connection with the present invention, the vibrators involved are likewise intended for working at or close to a natural frequency, and consequently likewise utilize the resonance effect, these vibrators are subsequently to be referred to as resonance vibrators.

In the method according to EP 0 870 585 A1, the exciter frequency f_{E} passes through a specific frequency range Δf during a compacting operation, reaching the natural frequency which is given or co-determined by the spring rate c of the spring of the mass-spring system, the spring in this case being designed as a hydraulic spring (using a compressible hydraulic medium) . The spring rate c, defined in the case of this method by the volume of the compressible medium, is also intended to be variable, to be precise according to column 2, lines 25 to 30 evidently for the purpose of adapting the method to the material masses of different sizes occurring in the case of products to be differently compacted. The material masses decisively influence the value of the overall co-oscillating mass m. According to the known formula f_{N}²=c/(m*4*π²), while maintaining for example a constant natural frequency f_{N}(at the end of the compacting operation), it is then necessary when adapting the spring rate c for it to be changed to the same degree as the oscillating mass m. A solution for changing the compressible volume enclosed in a compression chamber that is also obvious in view of the exciter apparatus described can be imagined in practice as comprising that, when there is a change of product, the compressible volume is changed by the existence of a number of compression chambers which are connected to one another in different combinations.

However, the method according to EP 0 870 585 A1 could also be considerably improved. The potential for improvement lies in the not yet fully utilized advantages of the resonance effect. This is so because, in the case of the known method, this effect is only used to the extent that this invention is evidently only concerned with reaching the accelerations occurring as a maximum at one natural frequency f_{N}. In other words: the maximum possible accelerations are used with the aid of the resonance effect only at one point of the overall frequency range Δf to be passed through during the compacting.

It is the object of the invention to use the advantages which arise from the resonance effect in the case of a resonance vibrator for compacting not only at one point of the overall range Δf of the exciter frequency f_{E} or the oscillating frequency of the mass-spring system used for the compacting, but over at least a specific portion of the overall range of the exciter frequency f_{E}(exciter frequency f_{E}=oscillating frequency) to be passed through. The solution achieving the object is presented in the independent patent claims. Further advantageous refinements of the invention are defined by the subclaims.

The advantage which can be achieved by means of the invention, along with the possible attainment of maximum accelerations by the resonance effect at all points of the frequency range Δf passed through, also consists in the following case: when it is not important at all to achieve a maximum possible oscillating excursion amplitude Aₘₐₓ (which corresponds to a maximum possible acceleration amplitude), but it is important to operate with a prescribed oscillating excursion amplitude A_{R} smaller than the maximum possible oscillating excursion amplitude (A_{R}<Aₘₐₓ) while passing through a range of the exciter frequency f_{E} (by regulating the power delivered by the exciter), it is possible to utilize the advantage that a considerably smaller exciter power W_{E} has to be produced at all points of the frequency range Δf passed through. This of course only applies on condition that, according to the invention, it is ensured while passing through a range of the exciter frequency f_{E} that the respectively changed exciter frequency f_{E} is always close to the natural frequency f_{N} (likewise adjusted during passing through) of the mass-spring system. [The exciter power WE to be converted on average over an oscillating period is in the resonance case (at ω₀):W_{E}=D*m*A_{R}²*ω₀³]. The exploitation of this particular advantage is of considerable practical significance, since the exciter power to be converted determines the outlay to be expended for the entire exciter device.

The invention is explained in more detail on the basis of 4 drawings.

FIG. 1 shows by the subFIG. 1a in an abstracted way the principle of an oscillating system with one mass and two springs and by subFIG. 1b a diagram with which the principle of the method of shifting the resonance curves over a specific frequency range is illustrated.

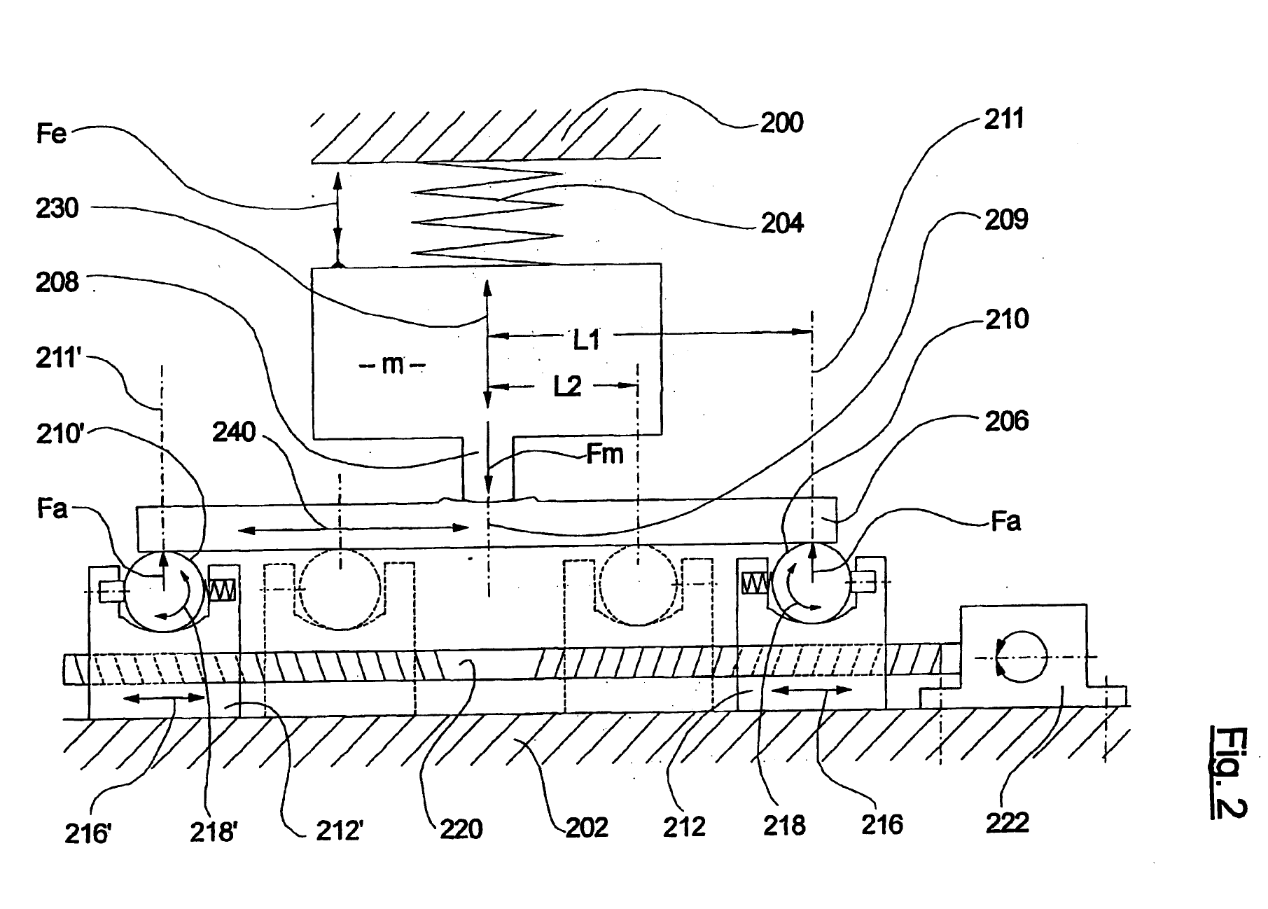

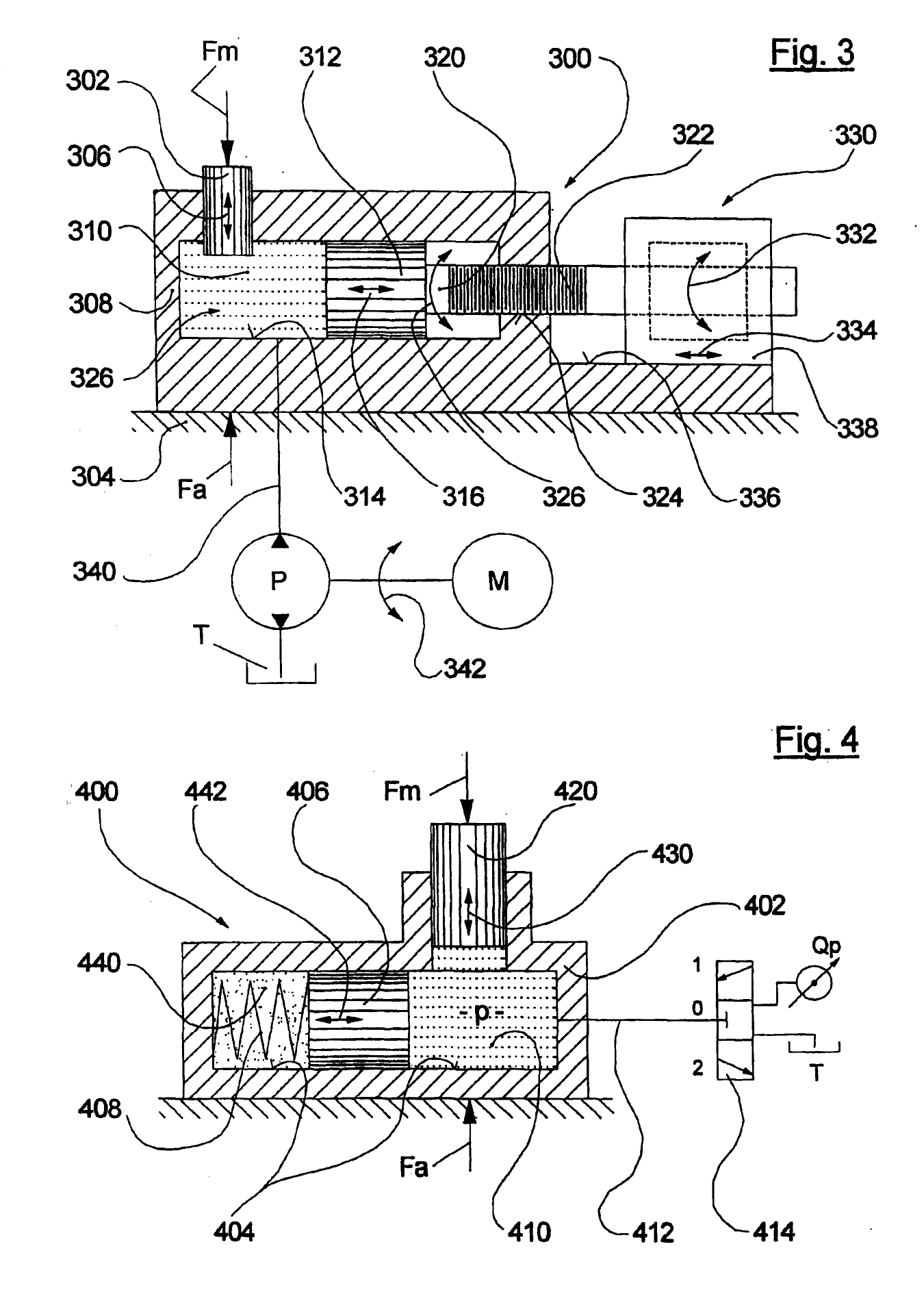

In FIGS. 2 and 3, springs which are adjustable with respect to the spring rate are shown in a schematized way, designed as a leaf spring and an oil spring, respectively.

FIG. 4 shows the generation of an additional force F_{z}, influencing the oscillating movement, using a pressure accumulator.

Represented in FIG. 1a is an oscillatory mass-spring system, as could be used in the case of a resonance vibrator used for carrying out the method according to the invention.

Symbolized by a rectangle 100 is the system mass “m” oscillating in the direction of the double-headed arrow 102. It is supported against a frame 104 by means of two springs, to be precise by means of an upper spring 106 with the spring rate c1 and by means of a lower spring 108 with the spring rate c2. The rectangle 100, symbolizing the mass m, is depicted in two positions, characterizing the reversal positions of the oscillating movement. The sum 2A of the two oscillating excursion amplitudes A is indicated by the position of the upper line 110. The middle position is assumed when the upper line 110 is in the position 112. The exciter actuator of an always necessary exciter is symbolized by the double-headed arrow 114 and the term Fe is intended to characterize the force amplitude of a harmonic force excitation, which acts on the mass m.

The spring 108 could in one case be a tension-compression spring subjected to compression and the spring 106 could be a tension-compression spring subjected to tension. If it is imagined that, when a middle position of the mass m (line 112) is assumed, the two similar springs are under a compressive prestress in such a way that, in this position, both are pressed together by a deformation excursion greater than the distance of the oscillating excursion amplitude A, in this case the lower spring 108 could be a compression spring that is subjected intensely to pressure and the upper spring 106 could be a compression spring that is subjected only slightly to pressure. Both assumed cases produce an identical oscillatory system. The term Fm symbolizes a mass force which is effective between the oscillating mass m and the spring 108 and the term Fa symbolizes a supporting force by means of which the spring 108 is supported against the frame, for example by means of another (connecting part not represented).

The natural frequency f_{N} for the mass-spring system represented is obtained according to a formula known to a person skilled in the art from the values of the mass m and the resulting spring rate c_{R}. The resulting spring rate c_{R} can be calculated, taking into consideration the individual spring rates of all the springs involved in the oscillation in an energy-accumulating way (there may also be more than the two springs shown), in the case of the oscillating system according to FIG. 1a from the sum of c1+c2. The oscillating system represented in FIG. 1a becomes a resonance vibrator if it is ensured that the exciter frequency f_{E} of the indicated exciter operates at least close to the natural frequency f_{N} or exactly coinciding with this frequency. An oscillation deflection of the oscillating excursion amplitude A tending to infinity is not to be feared, since, in the case of the resonance vibrator assumed here and also in the case of the resonance vibrator used for carrying out the method according to the invention, a damping “D” is always to be assumed, the damping D (symbolized in FIG. 1a by the double-headed arrow D) represents the energy extracted from the oscillatory system, this energy also including the useful energy to be delivered for the compaction. The method according to the invention operates by definition with a resonance vibrator with variable resulting natural frequency f_{N}, it being possible for the changing of the resulting natural frequency f_{N} to be brought about, inter alia, by changing of the resulting spring rate c_{R} of the oscillatory system. When a number of springs are involved, changing of the resulting. spring rate c_{R} may also take place by changing the spring rate of only a single spring, which is also preferred in the interests of a low outlay.

The single-mass-spring oscillator shown could also be operated for the purposes of the invention with the aid of a different type of set-up with springs or with the, aid of a different type of involvement of acceleration. forces (and deceleration forces) for carrying out enforced oscillations: for example., if dispensing with the spring 106, instead of its spring force a differently generated additional force Fz could be made to act on the mass m, or, if dispensing with the spring 106, the spring 108 could be used as a single spring, to be precise as a spring which can be loaded by tension and compression. It is intended that the additional force Fz characterized by the double-headed arrow can also symbolize two individual, different. additional forces that are used, one additional force Fz1 being effective in one direction and another additional force Fz2 being effective in the other direction. The two additional forces could be used together or just on their own.

In their effect on the oscillating movement, the additional forces Fz are intended preferably to be forces of substantially constant magnitude or only slightly variable magnitude, as can be generated for example hydraulically by using a hydraulic pressure accumulator (see also explanation of FIG. 4). If, for example, in the event that the spring 108 is a spring that can only be subjected to pressure, an additional force Fz is used, and this force acts during the upper half-oscillation (movement of the line 110 above the middle position 112) only from above downward onto the mass m with approximately constant magnitude, the use of the additional force Fz consequently has an effect similar to as though the acceleration due to gravity acting on the mass m were increased. This has the consequence that the additional force Fz therefore influences the execution time of the upper half-oscillation and therefore the execution time of the entire oscillating period and also the resulting natural frequency f_{N}. If, then, as preferred in its use, the additional force Fz is continually changed in its magnitude during the compacting operation while passing through the frequency range Δf, the resulting natural frequency f_{N} is consequently also influenced as though the spring rate c2 of the compression spring were continually adjusted.

FIG. 1b serves for illustrating the part of the invention relating to the method and shows a diagram with the exciter frequency f_{E} as a variable on the x-axis and with the oscillating excursion amplitude A as a function of fE with three resonance curves K1, K2 and K3. The resonance curves (the formulas of which are known to a person skilled in the art), which are determined in their curve profile between the values f_{E}=0 and f_{E}=f4 inter alia by the damping “D” (not given a figure here), represent the oscillating excursion amplitude profile of enforced oscillations of one and the same resonance vibrator (for example one according to the diagram shown in FIG. 1a). The maximum values A2 of the oscillating excursion amplitudes A assigned to the different frequency values f1, f2 and f3 are intended to show that the resonance vibrator has at least the three corresponding natural frequencies f1, f2 and f3. The maximum oscillating excursion amplitudes A2 of the three curves, represented with the same magnitude in FIG. 1b, are intended to be generated deliberately in this magnitude by corresponding influencing (regulating) of the co-acting exciter, but they could in principle also have different values.

Each curve represents an oscillating excursion amplitude profile which is excited over the entire functional range of the exciter frequency f_{E} by a force amplitude AF of constant magnitude of a harmonic exciter force generated by the exciter. It is evident from the profile of the curve K3, which, for example with f3, could represent that natural frequency f_{N} which is reached in the case of the method according to EP 0 870 585 A1 as the single natural frequency f_{N} when passing through a frequency range (for example Δf in FIG. 1b) of the exciter frequency f_{E}, that the oscillating excursion amplitude A has only a small value A4 (in the case of this curve) at a quite low exciter frequency f_{E}, the value corresponding to the static deflection of the resulting spring with the spring rate C_{R} by the force amplitude AF (that is: A4=AF/c_{R}). On the other hand, the same force amplitude AF at the natural frequency f3 has an oscillating excursion amplitude A2 that is approximately three times higher. It is inferred from this that, if the attainment of highest possible oscillating excursion amplitudes A (=highest possible oscillating accelerations “a”) at a specific given exciter frequency f_{E} is important, it is conducive to minimizing exciter force and also exciter power if the natural frequency f_{N} coincides with or is at least almost the same as the given exciter frequency f_{E}.

The inventive method exploits this effect, in that it has the aim that, when passing through a given frequency range Δf of the exciter frequency f_{E}, in the ideal case when each and every value f_{E} of the frequency range is reached, a resulting natural frequency f_{N} belonging to the respective value f_{E} will also have been set (for example by adjusting the resulting spring rate C_{R}). This means that, in the ideal case of continuous adjustment of the exciter frequency f_{E} over the range Δf, a simultaneous, likewise continuous synchronous co-adjustment of the resulting natural frequency f_{N} has to be carried out. The representation of the three curves in FIG. 1b is intended to show the following for an ideal method, in which a frequency range Δf of from f1 to f3 of the exciter frequency f_{E} is to be passed through during a compacting operation to be carried out: even when the natural frequency f1 is assumed at the beginning of the range limit, it is also intended that the resulting natural frequency f_{N} of the oscillatory mass-spring system should have been simultaneously set to this value. During the increase then occurring in the exciter frequency f_{E} via the value f2 up to the range limit f3, it is intended for the resulting natural frequency f_{N} to be taken along at the same time (and consequently the resonance curve applicable to each and every value of the resulting natural frequency f_{N} and likewise changing concomitantly with respect to the parameters A and D). [It should also be noted that similar conditions as in FIG. 1b arise if, instead of the sinusoidal profile of the exciter force (force amplitude AF) over time assumed in FIG. 1b, a different type of variation of the exciter force over time is used].

It is also evident that, in principle, there must be two equivalent procedures for exciting the material to be compacted in a compacting operation at resonant frequencies specific to the material of the parts of the mixture contained in it within a selected frequency range Δf with high accelerations, both of which procedures are also presented in the two independent patent claims 1 and 2:

In one case, the adjustable exciter frequency f_{E}(as an independent variable) is adjusted according to a given sequence function and the adjustable natural frequency f_{N} is made to track the given sequence function of the exciter frequency f_{E} in a given dependence (as a dependent variable), the given dependence possibly comprising )for example that a specific distance δf=f_{N}−f_{E} is maintained.

In the other case, the adjustable natural frequency f_{N}(as an independent variable) is adjusted according to a given sequence function and the adjustable exciter frequency f_{E} is made to track the given sequence function of the natural frequency f_{N} in a given dependence (as a dependent variable), the given dependence likewise possibly comprising for example that a specific distance δf =f_{N}−f_{E} is maintained.

The advantage of methods of this type means a considerable saving of exciter force and exciter power over the entire frequency range Δf and also makes it. possible for the first time on this basis to use quite different exciter methods (in comparison with the teaching of EP 0 870 585 A1) with in turn additional advantages on a different basis. In the practical execution of the method according to the invention, it is of course possible to deviate from the assumed ideal course of the method, as also described for example in some subclaims.

To carry out the adjustment of the resulting natural frequency f_{N} of the oscillatory mass-spring system necessary in the case of the method while passing through the frequency range Δf, the invention also provides, inter alia, an adjustment of the resulting spring rate c_{R} of the resulting spring of the system and/or an adjustment of the additional force Fz. If use is made of the adjustment of the resulting spring rate c_{R}, different solutions relating to the apparatus come into consideration, directed at the possible spring principles. The apparatuses described below on the basis of FIGS. 2 and 3, of an adjustable mechanical spring and an adjustable hydraulic spring for adjusting the resulting spring rate c_{R} of the resulting spring of the mass-spring system, show adjustable springs which in FIG. 1a could also represent the spring 108 or 106+108.

Coming into consideration as materials for adjustable mechanical springs are, inter alia, metal materials, elastomer materials and also fiber composite materials, it being possible for the spring elements to be subjected to tensile/compressive stresses, flexural stresses and also torsional stresses. Coming into consideration as spring adjusting systems, which serve for adjusting the natural frequency f_{N}, are quite generally those spring adjusting systems by which the oscillating energy that can be stored per half-oscillation in the springs and is derived from the kinetic energy can be changed. Before the specific configurational variant of an adjustable leaf spring according to FIG. 2 is explained, the functional principle of an adjustable mechanical spring according to the invention is to be set out quite generally below with reference to the concepts described in FIG. 1a:

In the case of a mechanical spring that is adjustable with respect to the spring rate, a spring can be deformed by two types of forces externally introduced into the spring, that is by mass forces Fm, which are effective between the oscillating mass m and the spring element, and by supporting forces Fa, by means of which the spring element is supported against another connecting part. For changing the spring rate, changing of the spring-effective length L of the spring element takes place, which spring-effective length L is determined by that length of the spring element in which the material stresses are built up and dissipated, with which stresses the spring energy is stored. Or: changing of the spring-effective spring volume V of the spring element takes place, the spring-effective spring volume V being determined by that spring volume in which the material stresses are built up and dissipated, with which stresses the spring energy is stored.

In the case of a spring subjected to bending, for example a leaf spring, the spring-effective length L or the spring-effective volume V is changed by the distance L between the point of introduction of the mass forces and the supporting forces being changed on an imaginary line in the main direction of extent of the leaf spring, two possibilities of spring loading existing for the leaf spring:

a) In the case of the principle B1 of the leaf spring that is restrained at one end and freely movable at one end, a point for the introduction of one type of externally introduced forces (for example mass forces) and a point for the introduction of the other type of externally introduced forces (for example supporting forces) is provided.

b) In the case of the principle B2 of the leaf spring that is freely movable at both ends (FIG. 2), a point for the introduction of one type of externally introduced forces (for example mass forces) and two points for the introduction of the other type of externally introduced forces (for example supporting forces) are provided.

In the case of a spring subjected to torsion, for example a torsion-bar spring, the mass forces Fm are substituted by mass-force torques Mm and the supporting forces Fa are substituted by supporting-force torques Ma and the spring-effective length L or the spring-effective volume V is changed by the distance L between the point of introduction of the mass-force torques Mm and the supporting-force torques Ma being changed on an imaginary line in the main direction of extent of the torsion-bar spring, two possibilities for introducing torque existing for the torsion-bar spring:

a) In the case of the principle T1 of the torsion-bar spring that is restrained at one end and freely rotatable at the other end, a point for the introduction of one type of externally introduced torques (for example mass-force torques) and a point for the introduction of the other type of externally introduced torques (for example supporting-force torques) are provided.

b) In the case of the principle T2 of the torsion-bar spring that is freely rotatable at both ends, a point for the introduction of one type of externally introduced torques (for example supporting-force torques) and two points for the introduction of the other type of externally introduced torques (for example mass-force torques) are provided.

Provided at at least one point of introduction of one type of externally introduced forces or torques on a spring of the type B1 or T1 and at at least two points of introduction of one type of externally introduced forces or torques on a spring of the type B2 or T2 are adjustable force-introducing elements, which can be displaced or shifted (preferably also during the execution of oscillations of the resonance vibrator) in a direction toward or in a direction away from the at least one point of introduction of the other type of externally introduced forces or torques. The adjustable force-introducing elements are of course supported against a corresponding supporting member during the possible displacement or shifting, by which the spring-effective length L or the spring-effective volume V is brought about for the purpose of changing the spring rate c of the spring. The displacement or shifting of the required adjustable force-introducing element or the two required adjustable force-introducing elements is best accomplished by a translationally or rotationally operating adjusting actuator in a way which can be predetermined with respect to the shifting distance. If the adjusting actuator is moved by motor (that is to say by applying an auxiliary force), it is preferably intended that an assigned controller is able to carry out the shifting of the force-introducing elements in a predeterminable way (for example programmably), in order thereby to set a predetermined natural frequency f_{N}.

The configuration of the apparatus according to the invention for adjusting the spring rate may be advantageously further designed as follows: a resonance vibrator according to the invention can be operated with only a single spring that can be loaded in two directions (for example an adjustable elastomer spring) or else with two springs, which undertake the storing of the spring energy in the case of different directions of oscillation (for example two leaf springs). In the event that two springs are used for storing the spring energy in different directions of oscillation, the following variants can be used: of the two springs used, only one need be designed as a spring that is adjustable with respect to the spring rate, since it is also possible for the natural frequency f_{N} to be varied in this way (when executing an oscillation with an unsymmetrical oscillation waveform per period). To avoid (for example when using a leaf spring) that, after releasing the stored kinetic energy of the oscillating mass, the relieved spring is loaded in a reverse direction, without an interruption in the force connection between the oscillating mass of the spring system and a spring occurring, it is envisaged to prestress the springs of the mass-spring system with respect to each other in such a way that, even in the case of the greatest intended oscillating excursion amplitude A, loading of the springs in the reverse direction does not occur at any of the springs after releasing the stored kinetic energy of the oscillating mass, and an interruption of the force connection between the oscillating mass of the spring system and a spring also does not occur.

Instead of a metallic material, it is advantageous to use as the spring material a fiber composite material, for example. a carbon-fiber composite material or a glass-fiber composite material, since, when a composite material of this type is used, a much higher energy density and deforming propensity can be attained in comparison with a metallic material for a comparable overall size.

In FIG. 2, 200 and 202 represent supporting members which are connected in a force-transferring manner to a frame (not represented but corresponding to 104 in FIG. 1a). The mass-spring system comprises the upper (non-adjustable) spring 204 (which is of secondary interest for further considerations), the mass m and the leaf spring 206. The mass m, the direction of oscillation of which is symbolized by the double-headed arrow 230, has on the underside a continuation 208, which acts as a force-introducing element and introduces the mass force Fm centrally into the leaf spring at the only one point of introduction of the first type 209. The leaf spring is supported at two points of introduction of the second type 211, 211′ by means of the supporting forces Fa against roller-shaped force-introducing elements 210 and 210′, which for their part transfer the forces to assigned roller carriers 212 and 212′, which latter are finally supported in terms of force against the supporting member 202. The main direction of extent of the leaf spring is symbolized by the double-headed arrow 240. The double-headed arrows 216 and 216′ indicate that the roller carriers 212 and 212′ can be displaced in both directions and, what is more, also under the pulsed loading by the supporting forces Fa. During their displacement, it is also allowed for the force-introducing elements 210 and 210′ to rotate, which is indicated by the double-headed arrows 218, 218′.

The displacement of the roller carriers 212 and 212′ in both directions is performed synchronously, which is brought about by a threaded spindle 220 with a counter-running thread. The threaded spindle 220 is driven by a motor-operated drive unit 222, which for its part is controlled by a controller (not represented). By means of the controller and the drive unit 222, the roller carriers 212, 212′, and consequently the points of introduction of the second type 211, 211′ for the supporting forces Fa, can be brought into any desired predeterminable positions, in order for example to produce the distances L1 or L2. The roller carriers brought into the positions L2 are indicated by dashed lines. The distances L1 and L2 relate to the point of introduction of the first type 209. It is clear to a person skilled in the art that the positions that can be set as desired for the points of introduction of the second type 211, 211′ are accompanied (within certain limits) by spring rates which can be set as desired of the leaf spring. The exciter force acting on the mass m is designated by Fe and is generated by an exciter actuator (not represented).

FIG. 3 shows a hydraulic spring 300 which is adjustable with respect to its spring rate and in the case of which the dynamic mass force Fm, derived from the mass m of the mass-spring system, is introduced into a spring piston 302, which is movably arranged in a compression housing 308, which is symbolized by the double-headed arrow 306. The piston acts against a compressible hydraulic medium 310, which is enclosed in a compression chamber 326 between the compression housing 308 and an adjusting piston 312 and which acts as a spring by the compression caused by the spring piston. The spring rate of the hydraulic spring is defined by the magnitude of the volume of the compressible medium. The mass force Fm, likewise to be transferred through the compression housing 308, generates as a force of reaction a supporting force Fa, by which the compression housing is supported against a supporting member 304. The hydraulic spring 300 could be installed in FIG. 1a instead of the spring 108.

Accommodated in the cylinder chamber 314 of the compression housing is the adjusting piston 312, which is connected in a rotationally fixed manner to the piston rod 320. The piston rod has on part of its surface an external thread 322, which is in engagement with an internal thread 324 in the compression housing. When there is an enforced rotation of the piston rod 320, the adjusting piston 312 is simultaneously moved rotationally and translationally (the latter indicated by the double-headed arrow 316), and consequently the size of the compression chamber 326 is also adjusted. The rotation of the piston rod 320 is brought about by an adjusting motor 330, into which the piston rod 320 is introduced and in which it is also axially mounted. During the rotation of the motor (symbolized by the double-headed arrow 332), the housing 338 of the motor is translationally shifted, sliding with its underside on a sliding surface 336 of the compression housing. The underside and sliding surface in this case simultaneously form a straight guide, by which twisting of the housing 338 is prevented.

The compression chamber 326 is connected via a line to a pump P, which can be driven by a motor M. Controlled by a reversal in the direction of rotation of the motor (indicated by double-headed arrow 342), the pump P can deliver a hydraulic volume either from a tank T into the compression chamber 326 or, conversely, from the compression chamber into the tank.

The adjustment of the spring rate of the hydraulic spring takes place by changing the size of the volume of the compressible hydraulic medium 310 as follows: at the same time as the adjustment of the size of the compression chamber 326 by the adjusting piston 312, an increase or reduction in the size of the volume of the hydraulic medium 310 is also performed by the pump P. The synchronous proceeding of the two functions is ensured by corresponding control of the adjusting motor 330 and of the pump motor M. Both synchronously proceeding functions can also be carried out during the compacting operation, which is made easier or possible by the fact that, once in every oscillating period, the pressure in the compression chamber 326 reaches a minimum.

Shown in FIG. 4 is the generation of an additional force Fz using a hydraulic-pneumatic pressure accumulator 400. A displacer housing 402 contains a cylinder chamber 404, in which a separator piston 406 is displaceably accommodated. On the left-hand side of the separator piston there is in the cylinder chamber 404 a compressed gas 440, the resilient property of which, existing in principle, is symbolized by a spring symbol 408. On the right-hand side of the separator piston there is in the cylinder chamber 404 a hydraulic medium 410, which is connected via a line 412 to a valve 414 with three positions. In position 1 of the valve, the hydraulic medium is connected to a pressure source Qp, the pressure of which is greater than the average pressure p in the hydraulic medium, so that the volume of the hydraulic medium increases, with displacement of the separator piston to the left and an increase in the pressure of the compressed gas 440. In position 2 of the valve 414, the hydraulic medium is connected to the tank T and the volume of the hydraulic medium is reduced, with displacement of the separator piston to the right and a decrease in the pressure of the compressed gas. In this way, the pressure p of the hydraulic medium 410 can be continuously changed within certain limits even during a compacting operation.

A displacer piston 420 is movably arranged in a corresponding cylinder chamber of the displacer housing 402 and is subjected to the force Fz, which corresponds to the magnitude of the hydraulic force exerted by the hydraulic pressure p on the displacer piston. Since the displacer piston transfers its force directly or indirectly onto the oscillating mass m, it also joins with the latter in carrying out its oscillating movements 430. The hydraulic volume displaced when carrying out the oscillating movements by the displacer piston 420 also brings about small displacing movements 442 on the separator piston 406, which however, by definition, are intended only to bring about a slight change in the pressure of the compressed gas 440, so that the force Fz remains substantially constant. The entire arrangement of the pressure accumulator 400 with its displacer piston 420 can be imagined in cooperation with the mass-spring system shown in FIG. 1a such that it is connected in parallel with the springs 106 or 108 or else, for example, that it is used in figure la instead of the spring 106.

Quite generally, the following can also be stated: the function which can be carried out by means of the invention of simultaneous adjustment of the exciter frequency f_{E} and the natural frequency f_{N} can also be meaningfully used when a simultaneous adjustment of the exciter frequency f_{E} and the natural frequency f_{N} also takes place with the compacting operation switched off or interrupted. In this case, too, the advantages of reduced exciter power or reduced exciter force can be used in the event that the compacting device has to be changed over for a different exciter frequency f_{E}, in order to meet the requirements when compacting the granular materials.

1. A method of compacting granular materials by means of a compacting device, which comprises a resonance vibrator designed as a linear oscillator with an oscillatory mass-spring system having a natural frequency, the mass of which system comprises a vibrating table, a mold for the material to be compacted and the material itself, and comprises an exciter for generating oscillations of the mass-spring system, which exciter can be regulated or controlled with respect to its exciter frequency, a frequency range Δf being selected for the exciter
frequency f_{E} or the natural frequency f_{N} and the corresponding frequency f_{E} or f_{N} being adjusted during the compacting operation within the frequency range from its lower value to its upper value in such a way that it passes through the selected frequency range Δf in a given sequence function,
the natural frequency being adjusted by means of an adjusting device during the compacting in such a way that it follows the exciter frequency, passing through the respectively selected frequency range Δf, or, when the natural frequency passes through the selected frequency range Δf, the exciter frequency follows in a predetermined dependence, in each case if appropriate while maintaining a specific frequency separation δf.

2. The method as claimed in claim 1, characterized in that the sequence function proceeds steadily or in discrete steps, the dependence of the following frequency f_{E} or f_{N} being adapted to the profile of the sequence function.

3. The method as claimed in claim 1 or 2, characterized in that the frequency distance δf is kept constant or is varied in a given way.

4. The method as claimed in one of claims 1 to 3, characterized in that the natural frequency f_{N} is adjusted by adjusting the amount at least of the kinetic energy of the mass-spring system that can be converted into spring energy during an oscillating half-period.

5. The method as claimed in one of claims 1 to 4, characterized in that the natural frequency f_{N} is performed by adjusting the resulting spring rate of the resulting spring of the mass-spring system and/or by adjusting an additional force Fz.

6. The method as claimed in claim 5, characterized in that the additional force Fz is set by means of the pressure of a hydraulic pressure accumulator.

7. The method as claimed in one of claims 1 to 6, characterized in that a full oscillating period is formed by two part-oscillating excursion periods with unequal part-period times.

8. The method as claimed in one of claims 1 to 7, characterized in that the exciter is influenced with respect to the portions of exciter energy that can be transferred from it to the oscillating mass of the mass-spring system in such a way that at least the positive or at least the negative oscillating excursion amplitudes are regulated on the basis of a value which can be given, in such a way that they are less than or equal to those oscillating excursion amplitudes which can be generated when the portions of exciter energy that can be transferred as a maximum from the exciter to the oscillating mass are applied.

9. The method as claimed in one of claims 1 to 8, characterized in that a stamp is used for pressing the granular material, the force of which stamp acting on the granular material or its spring force co-determines the natural frequency f_{N}.

10. An apparatus for compacting granular materials by means of a compacting device, which comprises a resonance vibrator designed as a linear oscillator with an oscillatory mass-spring system having a natural frequency, the mass of which system comprises a vibrating table, a mold for the material to be compacted and the material itself, and comprises an exciter for generating oscillations of the mass-spring system, which exciter can be regulated or controlled with respect to its exciter frequency,
a frequency range Δf being selectable for the exciter frequency f_{E} or the natural frequency f_{N} and the corresponding frequency f_{E} or f_{N} being adjustable during the compacting operation within the frequency range from its lower value to its upper value in such a way that it passes through the selected frequency range Δf in a given sequence function,
an adjusting device being provided, by which the natural frequency or the exciter frequency can be adjusted by the exciter or natural frequency passing through the frequency range Δf during the compacting in such a way that one respectively follows the other, if appropriate while maintaining a specific frequency distance Δf.

11. The apparatus as claimed in claim 10, characterized in that the mass-spring system comprises one or more individual springs.

12. The apparatus as claimed in claim 11, characterized in that the mass-spring system comprises a spring acting on the vibrating table from above it and a spring acting on the vibrating table from below it.

13. The apparatus as claimed in one of claims 10 to 12, characterized in that the compacting device comprises a stamp for pressing the granular material.

14. The apparatus as claimed in one of claims 10 to 13, characterized in that the natural frequency can be adjusted by adjusting the amount of at least the energy of the mass-spring system that can be converted into spring energy during an oscillating half-period.

15. The apparatus as claimed in claim 14, characterized in that the spring rate of a mechanical spring of the mass-spring system is adjustable.

16. The apparatus as claimed in claim 14 or 15, characterized in that the spring can be changed or adjusted with respect to an effective spring length L or a spring-effective spring volume V.

17. The apparatus as claimed in one of claims 10 to 16, characterized in that a controllable auxiliary motor drive is provided for adjusting the natural frequency.

18. The apparatus as claimed in one of claims 10 to 17, characterized in that the natural frequency is adjustable by means of the spring rate of a hydraulic spring of the mass-spring system.

19. The apparatus as claimed in claim 18, characterized in that the hydraulic spring has a compression chamber with an adjusting piston for the compression volume.

20. The apparatus as claimed in claim 19, characterized in that the size of the compression volume of the hydraulic medium of the hydraulic spring can be changed by means of a motor-driven pump, by which hydraulic medium can be delivered as a given volumetric flow into or out of the compression chamber.

21. The apparatus as claimed in one of claims 10 to 20, characterized in that the sequence function proceeds steadily or in discrete steps, the dependence of the following frequency f_{E} or f_{N} being adapted to the profile of the sequence function.
